(19) United States
(12) Patent Application Publication
(10) Pub. No.: US 2025/0296135 A1
(43) Pub. Date: Sep. 25, 2025

(54) Pouch Forming Device and Method

(71) Applicant: SK On Co., Ltd., Seoul (KR)

(72) Inventors: Taek Eon JEONG, Daejeon (KR); Seung Won CHOI, Daejeon (KR)

(21) Appl. No.: 18/973,274

(22) Filed: Dec. 9, 2024

(30) Foreign Application Priority Data
Mar. 21, 2024 (KR) 10-2024-0039258

(51) Int. Cl. B21D 28/26; H01M 50/105

(52) U.S. Cl. CPC B21D 28/26; H01M 50/105

(57) ABSTRACT

A pouch forming method may include: a disposing operation of disposing a pouch sheet between a die portion including a forming lower surface on which a pouch sheet is formed and a forming support portion disposed on the forming lower surface and a punch portion for forming the pouch sheet; a first forming operation of evacuating an internal space of the die portion and lowering the forming support portion in a direction of the forming lower surface to bend the pouch sheet; and a second forming operation of lowering the punch portion in a direction of the forming lower surface to press the pouch sheet.

### CROSS-REFERENCE TO RELATED APPLICATION(S)

This patent document claims the priority and benefits of Korean Patent Application No. 10-2024-0039258 filed on Mar. 21, 2024, the disclosure of which is incorporated herein by reference in its entirety.

### TECHNICAL FIELD

The present disclosure relates to a pouch forming device and method.

### BACKGROUND

Unlike a primary battery that cannot be charged, a general secondary battery is a battery that can be charged with and discharged of electricity, and is widely used in electronic devices such as mobile phones, laptop computers, camcorders, or the like, as well as electric vehicles. In particular, a lithium secondary battery has an operating voltage of approximately 3.6 V, a capacity approximately three times that of a nickel-cadmium battery or nickel-hydrogen battery, which are widely used as power sources for electronic equipment, and because the lithium secondary battery has a high energy density per unit weight, a degree of utilization thereof is trending to increase explosively.

A secondary battery may be classified as a coin-type battery, a cylindrical battery, a prismatic battery, and pouch-type battery, depending on the shape of a battery case. In a secondary battery, an electrode assembly installed inside the battery case is a power generation element that can be charged and discharged, the electrode assembly being comprised of a stacked structure of electrodes and a separator.

The electrode assembly may be approximately classified as a jelly-roll type, in which a separator is interposed between sheet-type cathodes and anodes coated with an active material, a stack type, in which a plurality of cathodes and anodes are sequentially stacked with a separator interposed therebetween, and a stack/folding type, in which stack-type unit cells are coiled with a long separation film.

Recently, a pouch-type battery having a structure in which a stack-type or stack/folding-type electrode assembly is embedded in a pouch-type battery case formed of aluminum laminate sheets has attracted a large amount of attention due to the low manufacturing costs, small weight, and easy shape deformation thereof, and the usage thereof is gradually increasing.

### SUMMARY

An aspect of the disclosure may provide a pouch forming device and a pouch forming method for preventing cracks in a corner portion of a pouch.

An aspect of the disclosure may provide a pouch forming device and a pouch forming method for preventing a pouch expansion phenomenon.

Another aspect of the disclosure may provide a pouch-type secondary battery formed according to a pouch forming method.

According to an aspect of the disclosure, a pouch forming method includes: a disposing operation of disposing a pouch sheet between a die portion including a forming lower surface on which a pouch sheet is formed and a forming support portion disposed on the forming lower surface and a punch portion for forming the pouch sheet; a first forming operation of evacuating an internal space of the die portion and lowering the forming support portion in a direction of the forming lower surface to bend the pouch sheet; and a second forming operation of lowering the punch portion in a direction of the forming lower surface to press the pouch sheet.

The first forming operation and the second forming operation may be performed simultaneously.

After the first forming operation is performed, the second forming operation may be performed.

At least one of the forming support portion and the punch portion may be lowered at a constant speed.

A lowering speed of the punch portion may be faster than a lowering speed of the forming support portion.

After the lowering of the forming support portion is completed, the punch portion may be lowered.

The forming support portion may be lowered and then be raised again, causing the punch portion to be lowered.

A distance between the forming support portion and the punch portion may be maintained to be 1 mm or less.

The pouch forming method according to an aspect of the disclosure may further include a speed control operation of controlling a moving speed of at least one of the forming support portion and the punch portion by a control unit.

The pouch sheet bent in the first forming operation may be bent to be convex downwardly.

In the second forming operation, a receiving portion in which an electrode assembly is received may be formed in the pouch sheet to have a shape, which is the same as an outer shape of the punch portion.

According to another aspect of the disclosure, a lithium secondary battery includes a pouch formed by the pouch forming method described above.

According to another aspect of the disclosure, a pouch forming device includes: a die portion having a forming groove; a punch portion disposed to face the forming groove, and provided to move relatively to the forming groove; a forming support portion provided to move relatively to the punch portion within the forming groove; and a control unit for controlling a moving speed of at least one of the forming support portion and the punch portion.

The die portion may further include an internal space formed by the forming groove and the forming support portion, and may further include a vacuum device forming vacuum pressure in the internal space.

The die portion may further include a fixing portion on which a pouch sheet is disposed.

A pouch forming device according to another aspect of the disclosure may further include a stripper disposed to be spaced apart from the fixing portion, and fixing a pouch sheet.

### BRIEF DESCRIPTION OF DRAWINGS

Certain aspects, features, and advantages of the disclosure may be illustrated by the following detailed description with reference to the accompanying drawings.

FIG. 1 is a schematic diagram schematically illustrating a pouch forming device of the present disclosure.

FIG. 2 is a schematic exploded perspective view of a pouch forming device according to an embodiment of the present disclosure.

FIG. 3 is a flowchart illustrating a pouch forming method of the present disclosure.

FIGS. 4 and 5 are process diagrams of a pouch forming device according to a pouch forming method of an embodiment.

FIGS. 6 to 8 are process diagrams of a pouch forming device according to a pouch forming method of another embodiment.

FIG. 9 is an image of a pouch obtained by comparing Example 1 and Comparative Example 1 manufactured according to the pouch forming method of the present disclosure.

### DETAILED DESCRIPTION

To manufacture a pouch-type battery, a deep drawing method is generally used. A deep drawing method is a pouch forming method using a mold, and is a technology for manufacturing a pouch according to a shape of a pre-formed mold. However, the deep drawing method may have a problem in that cracks and tearing may occur in the pouch due to material limitations when the pouch is formed beyond a certain depth.

Hereinafter, the present disclosure will be described in detail with reference to the drawings. However, this is only exemplary and the present disclosure is not limited to the specific embodiments described herein.

### Pouch Forming Device

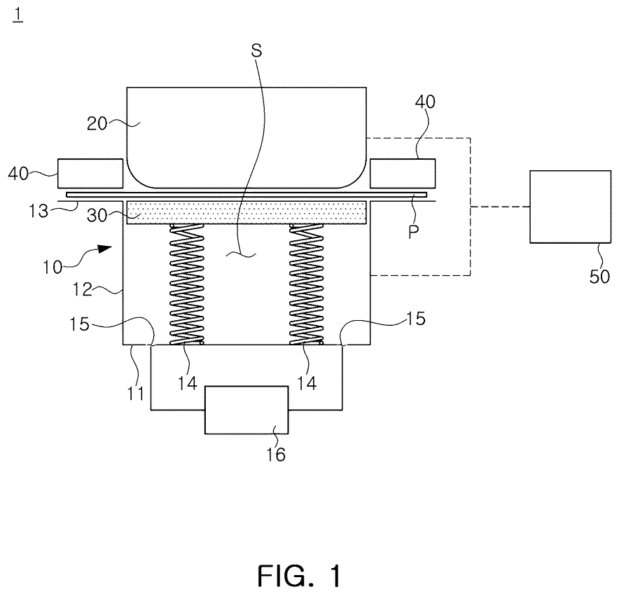

FIG. 1 is a schematic diagram schematically illustrating a pouch forming device 1 of the present disclosure. Referring to FIG. 1, in an embodiment of the present disclosure, a pouch forming device 1 that can prevent cracks in a corner portion of a pouch and prevent a pouch bulging phenomenon, may be provided.

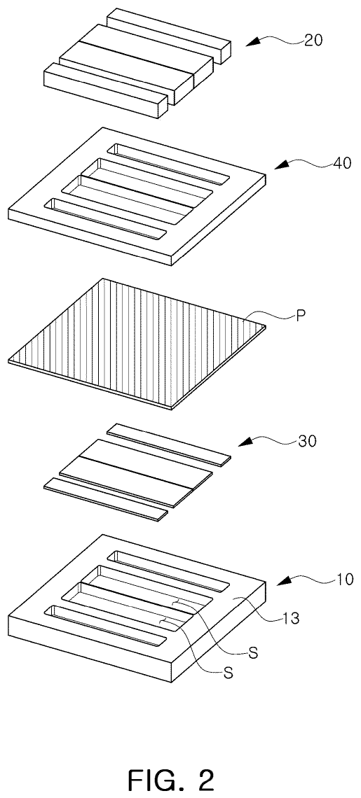

FIG. 2 is a schematic exploded perspective view of a pouch forming device 1 according to an embodiment of the present disclosure. Meanwhile, although a pouch sheet P used in the present disclosure is also illustrated in the drawings, this is illustrated together for convenience of understanding, and the pouch forming device 1 of the present disclosure may not include the pouch sheet P.

The pouch forming device 1 may include a die portion 10 having a forming groove S; a punch portion 20 disposed to face the forming groove S, and provided to move relatively to the forming groove S; a forming support portion 30 provided to move relatively to the punch portion 20 within the forming groove S; and a control unit 50 for controlling a moving speed of at least one of the forming support portion 30 and the punch portion 20.

The die portion 10 may include forming inner surfaces 11 and 12 forming a forming groove S and a fixing portion 13 disposed around the forming groove S on which the pouch sheet S is disposed. In FIG. 2, it is illustrated that a plurality of forming grooves S are provided to form a plurality of cup portions with a single pouch sheet P, but this is only for convenience of understanding and the present disclosure is not limited thereto. That is, even if at least one forming groove S is formed, it should be considered as belonging to the present disclosure.

A pouch sheet P may be formed on the forming lower surface 11. The forming lower surface 11 may have a structure, sunken inwardly to form an overall shape of a main body portion or a gas chamber (hereinafter, a receiving portion) forming a pouch of a secondary battery. The forming lower surface 11 may have a shape which is easy to receive the lowering punch portion 20. The shape of the forming lower surface 11 may be manufactured according to the shape of the receiving portion to be manufactured. For example, one embodiment of the forming lower surface 11 may be a rectangular parallelepiped shape, but an embodiment thereof is not limited thereto.

The die portion may further include an elastic portion 14. The elastic portion 14 may be disposed on the forming lower surface 11 in a height direction. A material of the elastic portion 14 is not particularly limited as long as the material is a material having elasticity. The at least one elastic portion 14 may be disposed on a lower surface of the forming lower surface 11, and specifically, the two or more elastic portions 14 may be disposed.

The forming support portion 30 may be disposed on the elastic portion 14, and specifically, the forming support portion 30 may have a form in which the forming support portion 30 is specifically fixed to an upper portion of the elastic portion 14. The forming support portion 30 may be lowered together with the lowering of the elastic portion 14, and may be raised together with the raising of the elastic portion 14.

The forming support portion 30 may be disposed to be spaced apart from a forming lower surface 11. A forming groove S formed by a forming lower surface 11 and a forming side surface 12 may form an internal space by the forming support portion 30. The internal space may be a space in which vacuum pressure is formed by a vacuum device 16 to be described later. The forming support portion 30 may be raised or lowered in the inside of the die portion 10 along the forming side surface 12. A distance between a side surface of the forming support portion 30 and the forming side surface 12 may be such that there may not be any empty space, and the forming support portion 30 may be maintained in a state of close contact with the forming side surface 12 while being raised or lowered within the die portion 10.

The forming support portion 30 is configured to support a lower surface of the pouch sheet P during the pouch forming process and bent the pouch sheet P, and the pouch sheet P may be disposed on the forming support portion 30. The pouch sheet P may be lowered together with the forming support portion 30 as the forming support portion 30 is lowered, and may be raised together with the forming support portion 30 as the forming support portion 30 is raised.

The die portion 10 may include a fixing portion 13, the fixing portion 13 may be connected to the forming side surface 12 and may be disposed to be parallel to the forming lower surface 11 in an upper portion of the forming side surface 12, and may be spaced apart from the forming support portion 30 by a predetermined distance and disposed on the same plane as the forming support portion 30.

A pouch sheet P may be disposed on the fixing portion 13 and the forming support portion 30. In addition, the pouch sheet P, disposed on the fixed portion 13, may be fixed without being moved, and the pouch sheet P, disposed on the forming support portion 30, may be moved together with the upward and downward movement of the forming support portion 30.

Referring to FIGS. 1 and 2, the pouch forming device 1 of the present disclosure may further include a stripper 40 disposed to be spaced apart from the fixing portion 13, and pressing the upper portion of the pouch sheet P to fix the pouch sheet P. The stripper 40 may be disposed to be spaced apart from an upper surface of the fixing portion 13 by a thickness of the pouch sheet P. In addition, the stripper 40 may have a hole formed according to the shape of the punch portion 20 therein so that the punch portion 20 may pass therethrough when the punch portion 20 is lowered.

The pouch sheet P fixed by the fixing portion 13 may be fixed except for a central portion of the pouch sheet P. As the forming support portion 30 is lowered, the central portion of the pouch sheet P may be lowered, a side portion of the pouch sheet P may be fixed by the fixing portion 13, and only the central portion of the pouch sheet P may be formed to be convex downwardly. As the forming support member 30 is raised, the central portion of the pouch sheet P may be raised, and only the side portion of the pouch sheet P may be fixed by the fixing member 13, and the central portion of the pouch sheet P may be formed to be convex upwardly.

In an embodiment of the present disclosure, the die portion 10 may further include an internal space formed by the forming groove S and the forming support portion 30, and may further include a vacuum device 16 forming vacuum pressure in the internal space. The die portion 10 may be connected to the vacuum device 16 by a vacuum hole 15 formed on the lower forming surface 11. The vacuum device 16 is not particularly limited as long as the vacuum device 16 is a device that can form vacuum pressure in the forming groove S by vacuum suction.

Meanwhile, the term ‘vacuum pressure’ as used in the present disclosure refers to pressure lower than atmospheric pressure in a surrounding region, so that air around the forming groove S is sucked into the vacuum device 16 through a vacuum hole 15, which may have a meaning including negative pressure. That is, the vacuum device 16 may form vacuum pressure in the forming groove S so that the forming support portion 30 is suctioned onto the vacuum hole 15 and held thereby.

When vacuum pressure is formed in the forming groove S by the vacuum device 16, the forming support portion 30 may be lowered in a direction of the forming lower surface 11. As the forming support portion 30 is lowered, vacuum pressure may be formed in a sealed space between the forming support portion 30, the forming side surface 12, and the pouch sheet P, and by the vacuum pressure between the forming support portion 30, the forming side surface 12, and the pouch sheet P, a central portion of the pouch sheet P may also be lowered, together with the forming support portion 30, and a side portion of the pouch sheet P may be fixed by the stripper 40 and the fixing portion 13, so that only the central portion of the pouch sheet P may be pressed and formed.

The punch portion 20 is disposed to be spaced apart from the forming support portion 30, and as the punch portion 20 is lowered in a direction of the pouch sheet P, the central portion of the pouch sheet P may be pressed and formed in a direction of the forming lower surface 11.

The pouch forming device of the present disclosure may include a control unit 50 for controlling a moving speed of at least one of the forming support portion 30 and the punch portion 20. The control unit 50 may be connected to the die portion 10 and the punch portion 20, and may be specifically connected to at least one of the forming support portion 30 and a vacuum device 16 in the die portion 10 to control a speed of the forming support portion 30 and control vacuum pressure of the vacuum device 16.

The control unit 50 may control a distance between the forming support portion 30 and the punch portion 20 by controlling the moving speed of the forming support portion 30 and the punch portion 20. Specifically, the control unit 50 may be connected to the vacuum device 16, the punch portion 20, and the forming support portion 30, and may control a lowering speed of the punch portion 20 and the distance between the forming support portion 30 and the punch portion 20 according to the lowering speed of the forming support portion 30 according to the vacuum pressure formed by the vacuum device 16. The lowering or raising speed of the punch portion 20 and the forming support portion 30 and the distance between the forming support portion 30 and the punch portion 20 are described later in the pouch forming method.

### Pouch Forming Method

Another embodiment of the present disclosure is to provide a pouch forming method that can prevent cracks in a corner portion of a pouch and prevent a pouch bulging phenomenon. Hereinafter, another embodiment of the present disclosure will be specifically described.

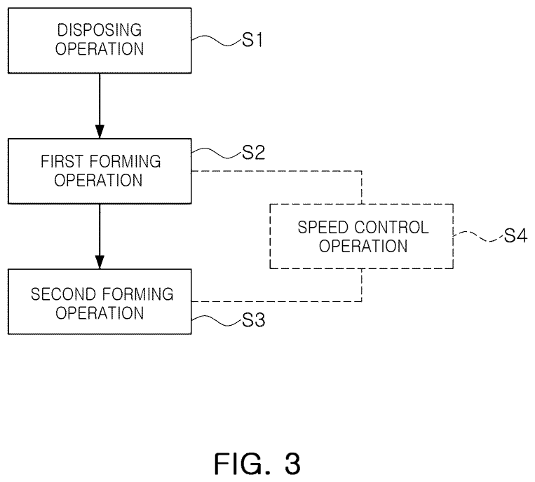

FIG. 3 is a flowchart illustrating a pouch forming method of the present disclosure. Referring to FIG. 3, a pouch forming method, which is another embodiment of the present disclosure, includes a disposing operation of disposing a pouch sheet P between a die portion 10 including a forming lower surface 11 on which a pouch sheet P is formed and a forming support portion 30 disposed on the forming lower surface 11 and a punch portion 20 for forming the pouch sheet P; a first forming operation of evacuating an internal space of the die portion 10 and lowering the forming support portion 20 in a direction of the forming lower surface 11 to bend the pouch sheet P; a first forming operation of evacuating an internal space of the die portion 10 and lowering the forming support portion 20 in a direction of the forming lower surface 11 to bend the pouch sheet P; and a second forming operation of lowering the punch portion 20 in a direction of the forming lower surface 11 to press the pouch sheet P.

A pouch forming method of an embodiment may include a disposing operation (S1). The disposing operation (S1) may be an operation of disposing a pouch sheet P on the forming support portion 30, and specifically, may be an operation of disposing a central portion of the pouch sheet P on the forming support portion 30.

In addition, the disposing operation (S1) may be an operation of disposing a pouch sheet P on a fixing portion 13. Specifically, the disposing operation (S1) may be an operation of disposing a side portion of the pouch sheet P on the fixing member 13.

The disposing operation (S1) may further include an operation of fixing the pouch sheet P. The die portion 10 may further include a fixing portion 13 which act as a support for fixing the pouch sheet P. A stripper 40 may be disposed on the pouch sheet P disposed on the fixing portion 13 so that a side portion of the pouch sheet P may be fixed by the stripper 40, and a central portion of the pouch sheet P may be disposed on the forming support portion 30.

A pouch forming method of an embodiment may include a first forming operation (S2). The first forming operation (S2) may be an operation of bending a pouch sheet P.

In the first forming operation (S2), the pouch sheet P may be bent to be convex downwardly by lowering the forming support portion 30 and simultaneously, lowering the central portion of the pouch sheet P in close contact with the forming support portion 30 along the forming support portion 30.

In the first forming operation (S2), the forming support portion 30 may be lowered in a direction of the forming lower surface 11 by vacuum pressure. Specifically, an internal space between the forming lower surface 11 and the forming support portion 30 may be made vacuum so that the forming support portion 30 may be lowered to a lower surface of the forming lower surface 11 by vacuum pressure, and at the same time, vacuum pressure may also be formed between the forming support portion and the pouch sheet P, so that the pouch sheet P may be lowered together with the forming support portion 30. When the pouch sheet P is formed under vacuum pressure, stress of aluminum within the pouch sheet P is dispersed, thereby reducing concentrated stress applied to the pouch sheet P, thereby preventing cracks and tearing of the pouch sheet P which occur during the pouch forming process. In addition, since the concentrated stress applied to the pouch sheet P is reduced when being formed by vacuum pressure, a receiving portion may be formed more deeply, so that a thick pouch-type secondary battery may be manufactured, and thus the energy density of the secondary battery may be improved.

A pouch forming method of an embodiment may include a second forming operation (S3). The second forming operation (S3) may be an operation of forming a receiving portion by pressing an upper portion of the pouch sheet, bent by the first forming operation (S2).

The punch portion 20 is a device for forming a pouch sheet P, and may be disposed to be spaced apart from the forming support portion 30. In addition, the punch portion 20 may press the upper portion of the bent pouch sheet P as the forming support portion 30 is lowered. As the punch portion 20 presses the upper portion of the pouch sheet P, a receiving portion of the pouch sheet P may be formed.

In the second forming operation (S3), a receiving portion in which an electrode assembly is received may be formed in the pouch sheet P to have a shape, which is the same as an outer shape of the punch portion. Specifically, an inner surface of the receiving portion may be manufactured according to the outer shape of the punch portion 20, and an outer surface of the receiving portion may be manufactured according to the shape of the die portion 10. More specifically, the outer surface of the receiving portion may be manufactured according to the shape of a side surface of the forming lower surface 11 and an upper surface of the forming support portion 30.

Since the shape of a lower surface of the receiving portion may be manufactured according to the shape of the lower surface of the punch portion 20, the lower surface of the punch portion 20 and the upper surface of the forming support portion 30 may have a shape parallel to the pouch sheet P. The punch portion 20 may be disposed to be spaced apart from the forming support portion 30, and may have a structure lowering in a direction of the forming lower surface 11 and a direction of the forming support portion 30. The raising and lowering method of the punch portion 20 is not particularly limited.

When forming a pouch by bending the pouch using vacuum pressure, a bulging phenomenon in which the central portion of the pouch sheet P bulges due to the vacuum pressure, may occur. When a bulging phenomenon occurs in the receiving portion, it becomes difficult to control a forming depth of the receiving portion, and wrinkles may occur on the exterior of the pouch, which may cause a problem such as poor quality.

Accordingly, the pouch forming method of an embodiment may form a pouch sheet P by controlling a distance between the forming support portion 30 and the punch portion 20.

By controlling the distance between the forming support portion 30 and the punch part 20, a time between the first forming operation (S2) and the second forming operation (S3) may be reduced, and a space in which the pouch is formed by vacuum pressure may be reduced, thereby preventing the bulging phenomenon of the receiving portion. The distance between the forming support portion 30 and the punch portion 20 may be controlled by controlling the speed of each of the forming support portion 30 and the punch portion 20. Specifically, the lowering and raising speeds of the forming support member 30 may be controlled by controlling the vacuum pressure of the forming lower surface 11. The lowering and raising speeds of the punch portion 20 may be controlled by the control portion 50 according to the distance with the forming support portion 30.

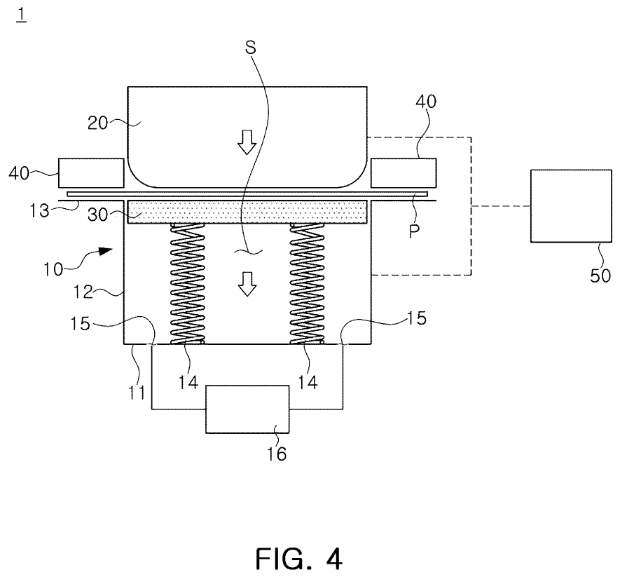

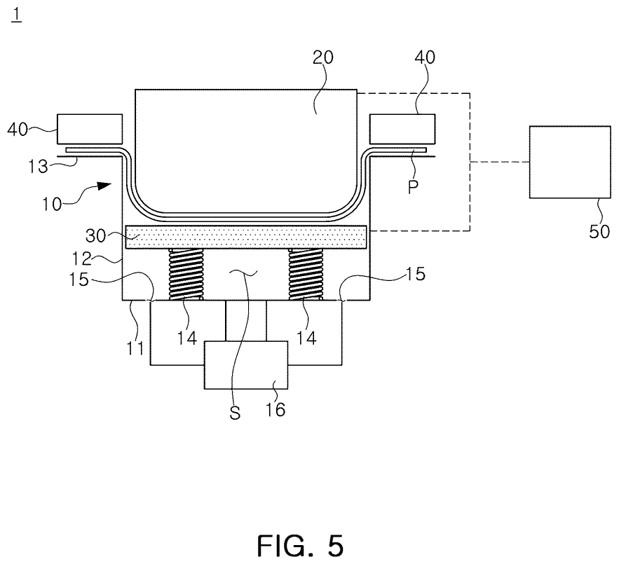

FIGS. 4 and 5 are process diagrams of a pouch forming device 1 according to a pouch forming method of an embodiment. Referring to FIGS. 4 and 5, an embodiment of the present disclosure may be an operation in which the first forming operation (S2) and the second forming operation (S3) are performed simultaneously.

According to an embodiment of the present disclosure, a lowering speed of the forming support portion 30 and a lowering speed of the punch portion 20 be the same. For example, the pouch may be formed while maintaining a distance between the forming support portion 30 and the punch portion 20 to be constant.

According to an embodiment of the present disclosure, the lowering speed of the punch portion 20 may be faster than the lowering speed of the forming support portion 30. For example, the distance between the forming support portion 30 and the punch portion 20 may become narrower.

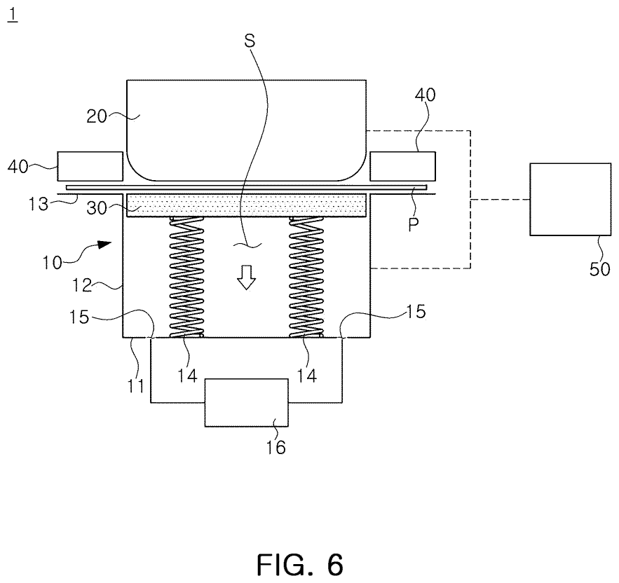

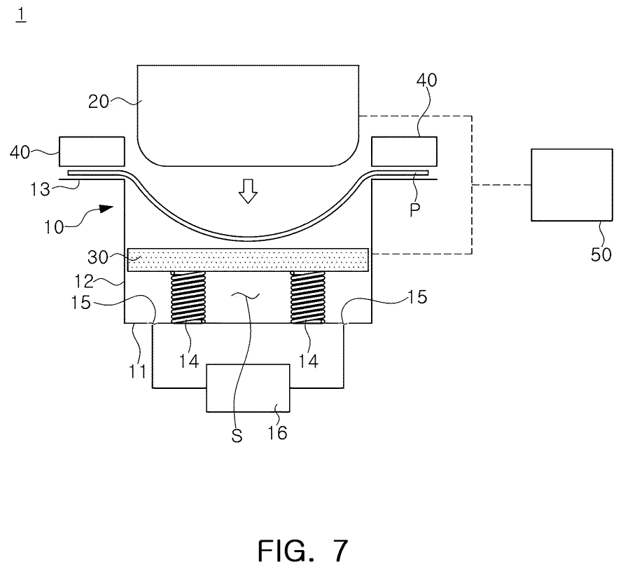

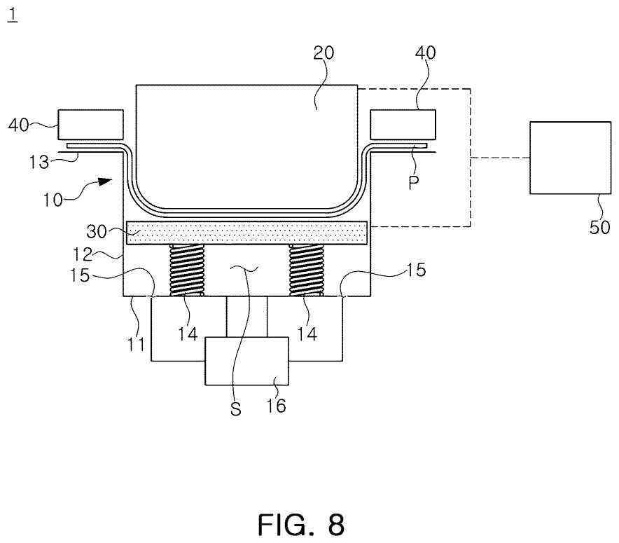

FIGS. 6 to 8 are process diagrams of a pouch forming device 1 according to a pouch forming method according to another embodiment of the present disclosure. Referring to FIGS. 6 to 8, another embodiment of the present disclosure may be an operation in which the second forming operation (S3) is performed after the first forming operation (S2) is performed.

According to another embodiment of the present disclosure, after the lowering of the forming support portion 30 is completed, the punch portion 20 may be lowered. For example, the distance between the forming support portion 30 and the punch portion 20 may be made as wide as possible and then gradually narrower.

According to another embodiment of the present disclosure, the forming support portion 30 may be lowered and then raised again, causing the punch portion 20 to be lowered. For example, the forming support portion 30 may be lowered first, and then the forming support portion 30 may be raised simultaneously, or the punch portion 20 may be lowered after the forming support portion 30 is raised.

The distance between the forming support portion 30 and the punch portion 20 may be maintained to be 1 mm or less, specifically 0.7 mm or less, and more specifically 0.5 mm or less. When the above-described range is maintained, a time between the first forming operation (S2) and the second forming operation (S3) may be reduced, and a space in which the pouch is formed by vacuum pressure may be reduced, thereby preventing a bulging phenomenon of the receiving portion.

Meanwhile, when the distance between the forming support portion 30 and the punch portion 20 exceeds 1 mm, it may become difficult to form a vacuum pressure, and a pouch expansion region may increase, causing a main body portion to bulge.

An embodiment of the present disclosure may further include a speed control operation (S4) for controlling a speed of at least one of the forming support portion 30 and the punch portion 20 by a control unit 50. In the speed control operation (S4), the control unit 50 may be connected to the die portion 10 and the punch portion 20, connected, and specifically, may be connected to at least one of the forming support portion 30 and a vacuum device 16 in the die portion 10 to control a speed of the forming support portion 30, and may control vacuum pressure of the vacuum device 16.

### Lithium Secondary Battery

According to another embodiment of the present disclosure, a secondary battery including a receiving portion formed by the pouch forming method described above and an electrode assembly accommodated in the receiving portion may be provided.

According to exemplary embodiments, an electrode assembly may be formed by repeatedly disposing a cathode, an anode, and a separator. In some embodiments, the electrode assembly may be of a winding type, a stacking type, a z-folding type, or a stack-folding type.

The cathode may include a cathode current collector and a cathode mixture layer disposed on at least one surface of the cathode current collector. The cathode current collector may include, for example, stainless steel, nickel, aluminum, titanium, or an alloy thereof, but the present disclosure is not particularly limited thereto.

The cathode mixture layer may include a cathode active material. The cathode active material may include a compound that can reversibly intercalate and deintercalate lithium ions, for example, lithium cobalt-based oxide particles (LCO), lithium manganese-based oxide particles (LMO), lithium nickel-based oxide particles (LNO), lithium nickel-cobalt-manganese-based oxide particles (NCM), lithium nickel-cobalt-aluminum-based oxide particles (NCA), lithium phosphate-iron-based oxide particles (LFP), lithium excess oxide particles (OLO), and the like, but the present disclosure is not particularly limited thereto.

The anode may include an anode current collector and an anode mixture layer disposed on at least one surface of the anode current collector, and is not particularly limited as long as it is a commonly used anode.

A separator may be interposed between the cathode and the anode. The separator may be configured to prevent electrical short-circuits between the cathode and the anode and to allow ion flow. Depending on the embodiment, a thickness of the separator may be 10 μm to 20 μm, but the present disclosure is not limited thereto.

For example, electrode tabs (cathode tabs and anode tabs) may protrude from the cathode current collector and anode current collector, respectively, and extend to one side portion of the case. The electrode tabs may be fused together with the one side portion of the case and connected to electrode leads (cathode leads and anode leads) extending or exposed to the outside of the case.

The case may be used as, for example, a pouch-type case, a prismatic case, a cylindrical case, a coin-type case, or the like, but can be specifically used as a pouch-shaped case. The pouch-type case may have a form in which a pouch exterior material surrounds the electrode assembly.

The pouch-type exterior material may include a metal layer, a sealant layer disposed on a bottom surface of the metal layer, and substrate layers disposed on an upper surface of the metal layer.

The bottom surface of the metal layer may face an interior of the secondary battery or battery cell, and the upper surface of the metal layer may face an exterior of the secondary battery or battery cell.

The metal layer may be provided as a barrier providing moisture permeability, chemical resistance, and gas barrier properties to the exterior material. For example, the metal layer may be manufactured from a metal foil, such as aluminum foil (Al foil).

The sealant layer may be a layer exposed on the inner side of the battery cell. The sealant layer may be a portion which is melt-bonded by a sealing process including a fusion process after the electrode assembly is received inside the exterior material. For example, sealant layers included in the upper pouch and the lower pouch may be fused to each other to form a sealing portion.

For example, sealant layers included in the upper pouch and the lower pouch may be fused to each other to form a sealing portion. Examples of the polyolefin resin may include polyethylene, polypropylene, block copolymers of polypropylene (e.g., block copolymers of propylene and ethylene), random copolymers of polypropylene (e.g., random copolymers of propylene and ethylene), terpolymers of ethylene-butene-propylene, or the like.

The substrate layer may include an intermediate substrate layer and an outer substrate layer. The intermediate substrate layer and the outer substrate layer may be sequentially stacked from the upper surface of the metal layer.

The substrate layer may include a polyester resin, a polyamide resin, an epoxy resin, an acrylic resin, a fluororesin, a polyurethane resin, a silicon resin, a phenol resin, and mixtures or copolymers thereof.

Examples of the polyester resins may include polyethylene terephthalate, polybutylene terephthalate, polyethylene naphthalate, polybutylene naphthalate, copolymerized polyester, polycarbonate, or the like. Examples of the polyamide resin may include nylon 6, nylon 6,6, a copolymer of nylon 6 and nylon 6,6, nylon 6,10, and polymethaxylylene adipamide (MXD6).

For example, the intermediate substrate layer may include a polyamide resin, such as nylon, and the outer substrate layer may include a polyester resin, such as polyethylene terephthalate (PET).

For example, the layers or films described above can be bonded to each other via an adhesive layer.

### EXAMPLE

Hereinafter, embodiments of the present disclosure will be further described with reference to specific experimental examples. Examples and Comparative Examples included in the experimental are examples merely illustrative of the present disclosure and do not limit the scope of the appended claims, and it is obvious to those skilled in the art that various changes and modifications to the embodiments are possible within the scope and technical idea of the present disclosure, and it is also natural that such changes and modifications fall within the scope of the appended claims.

### Manufacturing Examples

### Examples 1 to 5 and Comparative Examples 1 to 4

After disposing a pouch sheet having a thickness of 0.15 mm formed of an Al material on a forming support portion and a fixing portion, a stripper was disposed on the fixing portion to fix a side portion of the pouch sheet.

Pressure of a forming groove was lowered to 10⁻⁵ Torr or less by a vacuum device connected to a vacuum hole disposed on a forming lower surface, and the forming support portion and a central portion of the pouch sheet were lowered together in a direction of the lower surface of the forming.

By lowering the forming support portion and at the same time, lowering a punch portion while maintaining a distance between the forming support portion and the punch portion to be constant, by a control unit, and pressing an upper portion of the central portion of the pouch sheet by the punch portion to form the central portion of the pouch sheet, thereby forming a receiving portion.

In this case, the distance between the lowering forming support portion and the punch portion was maintained constant at the distance shown in Table 1 below.

TABLE 1

| | Distance between forming support |
|---|---|
| | portion and punch portion (mm) |
| Example 1 | 0.15 |
| Example 2 | 0.3 |
| Example 3 | 0.5 |
| Example 4 | 0.7 |
| Example 5 | 1 |
| Comparative | 5 |
| Example 1 | |
| Comparative | 7 |
| Example 2 | |
| Comparative | 10 |
| Example 3 | |
| Comparative | 15 |
| Example 4 | |

### Evaluation Example

A degree of pouch expansion of Examples 1 to 5 and Comparative Examples 1 to 4 was confirmed by measuring a difference in heights between a corner of a pouch receiving portion and a central portion of the pouch receiving portion, which was shown in Table 2 below.

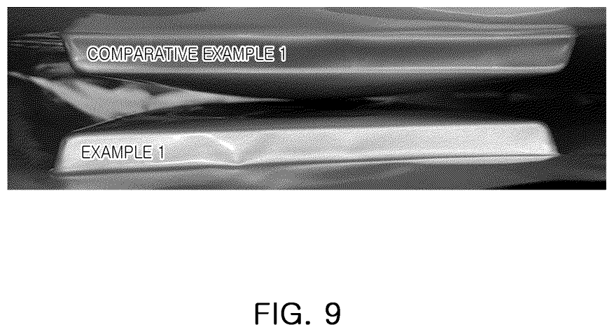

Meanwhile, a pouch bulging phenomenon of Example 1 and Comparative Example 1 was photographed, which was shown in FIG. 9.

TABLE 2

| | Pouch expansion (mm) |
|---|---|
| Example 1 | 1.2 |
| (REF.) | |
| Example 2 | 1.3 |
| Example 3 | 1.5 |
| Example 4 | 1.6 |
| Example 5 | 1.9 |
| Comparative | 2.3 |
| Example 1 | |
| Comparative | 2.9 |
| Example 2 | |
| Comparative | 3.5 |
| Example 3 | |
| Comparative | 5.1 |
| Example 4 | |

Referring to Table 2, it can be confirmed that Examples 1 to 5 in which a distance between a forming support portion and a punch portion is 1 mm or less, has a low degree of pouch expansion, thereby alleviating the pouch bulging phenomenon.

On the other hand, in Comparative Examples 1 to 4 in which the distance between the forming support portion and the punch portion exceeds 1 mm, the degree of pouch expansion is high, and it can be confirmed that the pouch bulging phenomenon occurs.

Referring to FIG. 9, it can be visually confirmed that in Comparative Example 1, in which the distance between the forming support portion and the punch portion is relatively long, a bulging phenomenon occurs, as in compared to Example 1.

The above description is merely an example of applying the principles of the present disclosure, and other configurations may be further included without departing from the scope of the present disclosure.

As set forth above, according to an embodiment of the present disclosure, a pouch formed according to a pouch forming device and a pouch forming method may prevent cracks in a corner portion of the pouch.

A pouch formed by a pouch forming device and a pouch forming method may suppress an expansion phenomenon of a main body portion of the pouch.

Only specific examples of implementations of certain embodiments may be described. Variations, improvements and enhancements of the disclosed embodiments and other embodiments may be made based on the disclosure of this patent document.

What is claimed is:

1. A pouch forming method, comprising:
a disposing operation of disposing a pouch sheet between a die portion including a forming lower surface on which a pouch sheet is formed and a forming support portion disposed on the forming lower surface and a punch portion for forming the pouch sheet;
a first forming operation of evacuating an internal space of the die portion and lowering the forming support portion in a direction of the forming lower surface to bend the pouch sheet; and
a second forming operation of lowering the punch portion in a direction of the forming lower surface to press the pouch sheet.

2. The pouch forming method of claim 1, wherein the first forming operation and the second forming operation are performed simultaneously.

3. The pouch forming method of claim 1, wherein, after the first forming operation is performed, the second forming operation is performed.

4. The pouch forming method of claim 2, wherein at least one of the forming support portion and the punch portion is lowered at a constant speed.

5. The pouch forming method of claim 2, wherein a lowering speed of the punch portion is faster than a lowering speed of the forming support portion.

6. The pouch forming method of claim 3, wherein, after the lowering of the forming support portion is completed, the punch portion is lowered.

7. The pouch forming method of claim 3, wherein the forming support portion is lowered and then is raised again, causing the punch portion to be lowered.

8. The pouch forming method of claim 1, wherein a distance between the forming support portion and the punch portion is maintained to be 1 mm or less.

9. The pouch forming method of claim 1, further comprising:
a speed control operation of controlling a moving speed of at least one of the forming support portion and the punch portion by a control unit.

10. The pouch forming method of claim 1, wherein the pouch sheet bent in the first forming operation is bent to be convex downwardly.

11. The pouch forming method of claim 1, wherein, in the second forming operation, a receiving portion in which an electrode assembly is received is formed in the pouch sheet to have a shape, which is the same as an outer shape of the punch portion.

12. A lithium secondary battery including a pouch formed by the pouch forming method of claim 1.

13. A pouch forming device, comprising:
a die portion having a forming groove;
a punch portion disposed to face the forming groove, and provided to move relatively to the forming groove;
a forming support portion provided to move relatively to the punch portion within the forming groove; and
a control unit for controlling a moving speed of at least one of the forming support portion and the punch portion.

14. The pouch forming device of claim 13, wherein the die portion further comprises an internal space formed by the forming groove and the forming support portion, and
a vacuum device of forming vacuum pressure in the internal space.

15. The pouch forming device of claim 13, wherein the die portion further comprises a fixing portion on which a pouch sheet is disposed.

16. The pouch forming device of claim 15, further comprising:
a stripper disposed to be spaced apart from the fixing portion, and fixing the pouch sheet.
